(19) United States
(12) Patent Application Publication
(10) Pub. No.: US 2011/0309652 A1
(43) Pub. Date: Dec. 22, 2011

(54) Air Guiding Device

(75) Inventors: Marcel EICHENTOPF, Neufahm (DE); Lars Naeve, Muenchen (DE); Vanja Zivkov, Muenchen (DE); Christian Seitz, Unterfoehring (DE)

(73) Assignee: Bayerische Motoren Werke Aktiengesellschaft, Muenchen (DE)

(21) Appl. No.: 13/221,238

(22) Filed: Aug. 30, 2011

Related U.S. Application Data
(63) Continuation of application No. PCT/EP2010/057177, filed on May 25, 2010.

(30) Foreign Application Priority Data
May 26, 2009 (DE) 10 2009 022 684.2

(51) Int. Cl. B62D 35/02

(52) U.S. Cl. 296/180.1

(57) ABSTRACT

An air guiding device on a wheel suspension element of a rear axle of a motor vehicle extends approximately transversely to the longitudinal direction of the motor vehicle. The air guiding device includes an element that extends substantially in a horizontal plane and is divided into a front section and a rear section. The two sections extend upwardly at different angles from a horizontal plane.

### CROSS-REFERENCE TO RELATED APPLICATIONS

This application is a continuation of PCT International Application No. PCT/EP2010/057177, filed May 25, 2010, which claims priority under 35 U.S.C. §119 from German Patent Application No. DE 10 2009 022 684.2, filed May 26, 2009, the entire disclosures of which are herein expressly incorporated by reference.

### BACKGROUND AND SUMMARY OF THE INVENTION

The invention relates to an air guiding device on a wheel suspension element of a rear axle of a motor vehicle, which wheel suspension element extends approximately transversely to the driving direction of the vehicle.

An air guiding device of the above-mentioned type is known, for example, from German Patent document DE 42 14 912 A1. The known air guiding device is fastened to a lower control arm of a rear wheel suspension and guides the air flow past the control arm as well as past additional parts of the wheel suspension. As a result, a reduction of the aerodynamic drag is achieved in the area for the rear wheel suspension. The effective area of the air guiding device is essentially arranged in an approximately vertical plane, in the manner of a spoiler, which is arranged in front of the elements of the rear wheel suspension and guides the air flow away over the components of the wheel suspension during the drive of the motor vehicle.

In addition, an also approximately vertically oriented air guiding device is known from European Patent document EP 0 778 187 B1, which air guiding device deflects the air flow at the underbody of the motor vehicle for cooling the wheel brakes. In addition, a flat covering in the floor area close to the rear axle of a motor vehicle is known from European Patent Document EP 0 888 956 A1, which covering has an elastic construction and thereby permits movements of the rear axle in that the covering is elastically deformed.

It is an object of the invention to further develop the known air guiding device with the goal of achieving an aerodynamically particularly effective form.

This and other objects are achieved by an air guiding device on a wheel suspension element of a rear axle of a motor vehicle, which wheel suspension element extends approximately transversely to the driving direction of the vehicle. In its installed position at the motor vehicle, the air guiding element extends essentially approximately horizontally and is divided into a section in front of the rear axle as well as a section behind the rear axle. The two sections extend at different angles with respect to a horizontal plane. The angle in the section in front of the rear axle is greater than the angle in the section behind the rear axle. The two sections—starting from their transition area—are oriented in an upward direction.

The invention advantageously provides an air guiding device which is oriented essentially approximately parallel to the roadway while being shaped according to aerodynamic aspects, having a front as well as a rear section which are mutually coordinated and take into account the aerodynamic conditions in front of as well as behind the rear axle. The two sections of the air guiding device are set at different angles with respect to a horizontal plane. In this case, the two sections do not necessarily have a plane-surface construction but may be two- or three-dimensionally curved, so that the characteristic of the “different angles” may, if necessary, relate to a center plane extending through the surface of the respective section. Starting from the transition area between the two sections, the two sections of the air guiding device extend diagonally upward. Thus, in a lateral view, the air guiding device has a tub-shaped construction that is open in the upward direction. However, particularly the rear section of the air guiding device may extend almost parallel to the roadway.

The “in front of/behind the rear axle” position indication relates to the connection line of the wheel centers of the rear wheels.

As a result of the adjusting of the two sections, if required, in connection with a suitable profiling and/or contouring of the air guiding device, a high aerodynamic effectiveness is achieved, with a low-resistance flow around the rear axle area and a low-loss flowing-off of the underbody flow behind the rear axle. Because of the invention, fractions of the flow in the transverse direction of the vehicle are reduced and turbulences of the flow are minimized. The loss-afflicted pressure rise in the area of the rear axle is converted to a directed flow with a higher kinetic energy as a result of the design of the air guiding device. As a result of the invention, the aerodynamic drag of the motor vehicle is reduced, and the aerodynamic lift at the rear axle is minimized. In an optimized manner, the underbody flow is guided past the components of the rear axle. As a result, it is prevented that the flow impacts directly on the axle components, thereby splits into different directions, penetrates into the underbody section in the area of the rear axle, and there, in a drag-increasing manner, flows around and through different components.

In an advantageous further development of the invention, the transition area extends approximately at the level of the lower end section of the wheel suspension element to which the air guiding device is fastened. The wheel suspension element is therefore covered, in which case the air guiding device is arranged as close as possible to the wheel suspension element in order not to limit the ground clearance of the motor vehicle. As a rule, the covering by the air guiding element is not limited to the corresponding wheel suspension element but includes additional components of the rear axle.

In a preferred embodiment of the invention, a fuel tank, which is surrounded by the air stream, is situated in front of the rear axle. Although this flow around the fuel tank increases the drag coefficient of the motor vehicle, it is necessary for cooling the fuel tank. In order to reduce the above-described flow through the rear axle area of the motor vehicle, the fuel tank is adjoined by the leading edge of the air guiding device. For preventing the flowing of the air stream into the rear axle area, the leading edge of the air guiding device is preferably arranged above the bottom side of the fuel tank. As used herein, the term “fuel tank” may be a receptacle for accommodating liquid or gaseous fuel as well as, for example, a receptacle for accommodating at least one cell for storing electric energy.

The air guiding device according to the invention cannot completely prevent the flowing of air into the rear axle area. In order to permit a flowing of the air out of the rear axle area, according to a preferred embodiment of the invention, a clearance between the air guiding device and the underbody of the motor vehicle, for example, in the shape of an outlet gap, is provided in the region of the end area of the air guiding device, which faces away from the driving direction.

For increasing the aerodynamic effectiveness, the air guiding device may have a spoiler edge or another flow guiding measure, such as a “countersweep”, at its end section facing away from the driving direction.

The air guiding device preferably extends along the entire, or at least almost the entire, width of the wheel suspension element, whereby a flow through the rear axle area is effectively reduced. Depending on the further development of the rear axle area, the right and/or the left air guiding device may also extend beyond the respective wheel suspension element in the direction of the vehicle center.

The air guiding device may also have a separate air guiding surface, for example, in the form of a bend, in order to feed cooling air to the wheel brake of the rear wheel of the rear axle in a targeted manner, as known per se from European Patent document EP 0 778 187 B1.

As a result of the arrangement of the air guiding device approximately in a horizontal plane, the air guiding device is particularly suitable for covering a part of the cutout of the rear axle in the underbody of the motor vehicle, which cutout is open in the downward direction. The word “covering” should not be understood to mean a complete closing-off of the rear axle cutout. On the contrary, the air guiding device according to the invention has the effect that the flow does not take place through the rear axle area but under it. A complete shutting-off of the rear axle area cannot be achieved. However, it is an object of the invention to guide the main portion of the air flowing at the underbody during the drive of the motor vehicle past the rear axle cutout of the motor vehicle and therefore achieve a flow under the rear axle area and to minimize the flow through the rear axle area. According to the invention, this is achieved by means of an air guiding device arranged at a wheel suspension element of the rear axle, preferably at a lower control arm. For the residual air, which will nevertheless flow into the rear axle area, an outlet is to be provided behind the rear axle, between the air guiding device and the underbody, in order to allow a flowing-out of the residual air.

The degree of closure depends on the shape and the size according to the flow topology. It is a goal to allow as little air mass as possible to penetrate into the area of the rear axle cutout in the underbody of the motor vehicle but to simultaneously not block the ventilation from the rear axle cutout.

The air guiding device according to the invention is preferably provided at both wheels of the rear axle of the motor vehicle. Depending on the further development of the underbody, which may differ on the right and the left vehicle side, for example, because of the direction of the exhaust gas system, the right and the left air guiding device may have different designs.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic lateral view of the area of a rear axle of a known motor vehicle;

FIG. 2 is a schematic lateral view of the area of a rear axle of a motor vehicle, having an air guiding device according to a first embodiment of the invention;

FIG. 3 is a view of a second embodiment of the invention corresponding to FIG. 2;

FIG. 4 is a schematic view of the geometrical relationships on an air guiding device according to the invention;

FIG. 5 is a sectional view of various further developments of air guiding devices according to the invention;

FIG. 6 is a sectional view of various further developments of the front section of air guiding devices according to the invention;

FIG. 7 is a sectional view of various further developments of the rear section of air guiding devices according to the invention;

FIGS. 8 and 9 are schematic bottom views of air guiding devices of different widths; and

FIG. 10 is a bottom view of various further developments of air guiding devices.

### DETAILED DESCRIPTION OF THE DRAWINGS

FIG. 1 illustrates the area of a rear axle of a known motor vehicle, which area, in its entirety, has the reference number 102. The individual components of the rear axle 102, which are used for suspending the rear wheels 104, have the reference numbers 106, 108 and 110. A fuel tank 112 is arranged in front of the rear axle 102. The bottom side 113 of the fuel tank 112 extends approximately as an extension of the largely flat underbody 114 of the motor vehicle. A largely flat underbody 116 also adjoins the rear axle 102.

The underbody flow occurring during the drive of the motor vehicle is symbolized by arrows 118. While the flow around the fuel tank 112 is desirable for the purpose of cooling (arrows 118a), the flow through the area of the rear axle 102 takes place in an undesirable manner (arrows 118), with considerable flow losses because of the fissured rear axle 102.

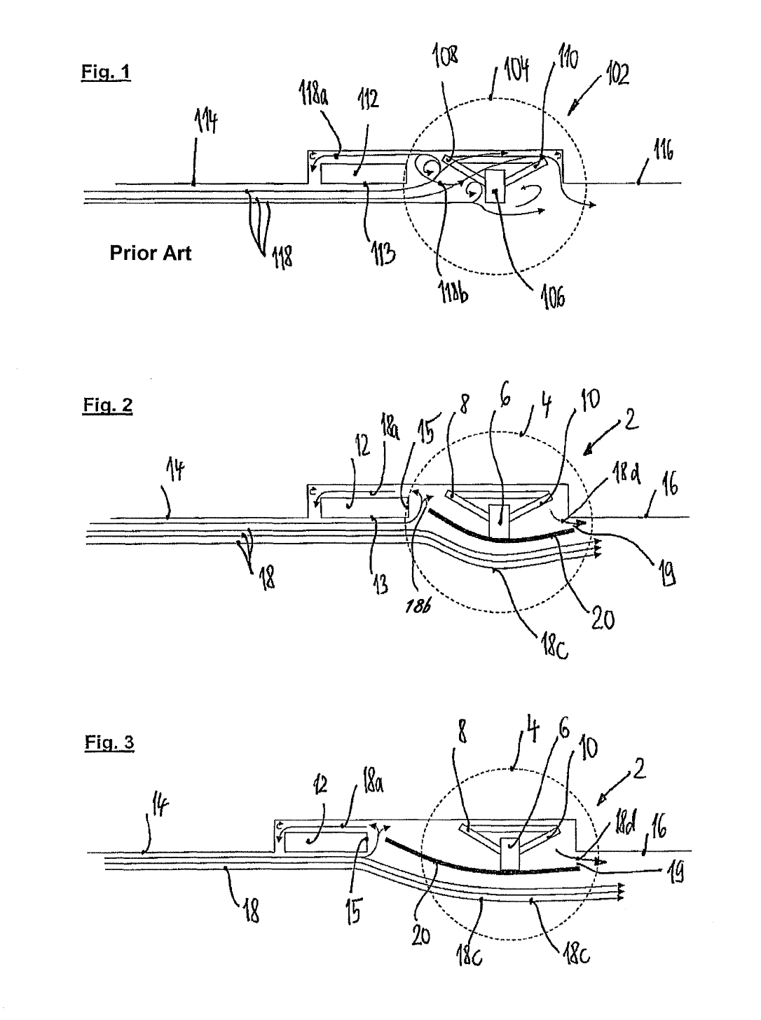

In contrast, in FIG. 2, a further development of the area of a rear axle according to the invention, in its entirety, has the reference number 2. The individual components of the rear axle 2, which are used for suspending the rear wheels 4, have the reference numbers 6, 8 and 10. A fuel tank 12 is arranged in front of the rear axle 2. The bottom side 13 of the fuel tank 12 extends approximately as an extension of the largely flat underbody 14 of the motor vehicle. A largely flat underbody 14, which is formed, for example, by a trunk bottom, a muffler of an exhaust gas system, etc., adjoins the rear axle 2. In principle, the areas 14 and 16 of the underbody can obtain a shape that is as flat and as favorable to the flow as possible as a result of covering components which are not shown.

The underbody flow occurring during the drive of the motor vehicle is symbolized by arrows 18. The flow around the fuel tank 12 for the purpose of cooling is desired (arrows 18a). In order to reduce the flow through the area of the rear axle 2, an air guiding device 20 is provided on the underside of the wheel suspension element 6, for example, of a lower control arm. Thus, a flow under the area of the rear axle 2 is achieved which is illustrated by arrows 18c. Because a complete shutting-off of the cutout in the underbody 14, 16 for the rear axle is not possible, a slight flow will remain through the rear axle cutout in the underbody 14, 16 of the motor vehicle (arrow 18b). A clearance in the form of a gap 19 between the underbody 16 and the end section of the air guiding device 20, which faces away from the driving direction, permits the outflow of this portion of the underbody flow, symbolized by the arrows 18d, from the rear axle cutout in the underbody 14, 16.

FIG. 3 shows a second embodiment of the invention, with a distance between the fuel tank 12 and the rear axle 2, which is greater compared with the embodiment of FIG. 2. In this case, the front end section of the air guiding device 20, which faces the driving direction, is situated higher than in the embodiment of FIG. 2 in order to effectively reduce the penetration of the underbody flow into the area of the rear axle 2.

In both embodiments according to FIGS. 2 and 3, the front end section of the air guiding device 20, which faces the driving direction, is situated above the bottom side 13 of the fuel tank and directly adjacent to the back side 15 of the fuel tank 12.

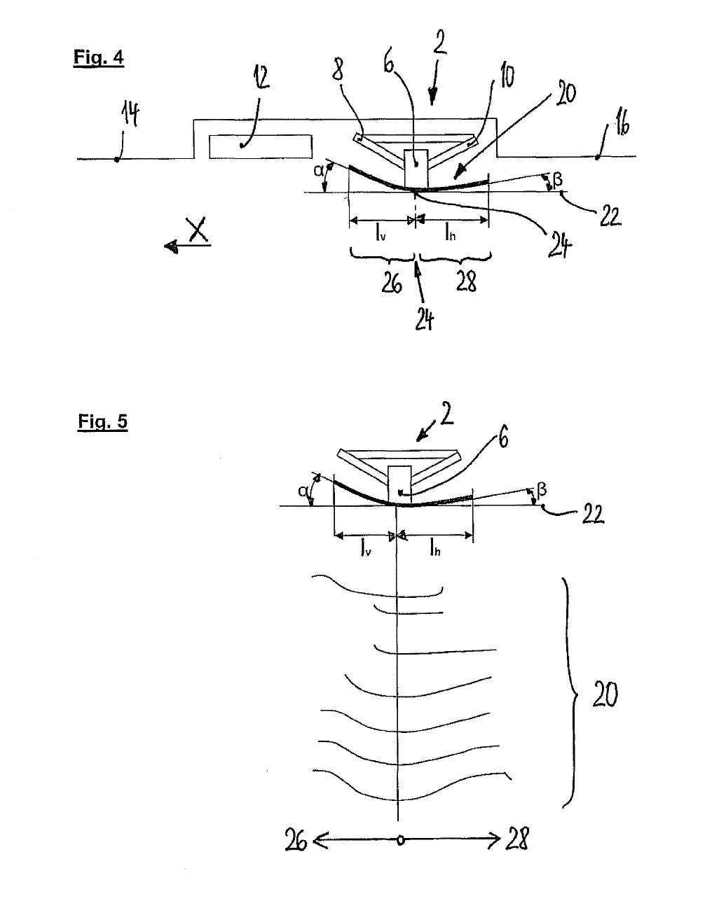

FIG. 4 explains the geometrical relationships on the air guiding device 20. The air guiding device 20 is divided into a front and into a rear section 26 and 28 respectively, with a narrow transition area 24 situated in-between. The two sections 26 and 28 of the air guiding device 20 are curved in the longitudinal direction X of the motor vehicle and extend at a median angle α and β respectively with respect to a horizontal plane 22. The horizontal lengths of the two sections 26 and 28 are marked Iᵥ and Iₕ.

FIG. 5 shows a part of the representation of FIG. 4 as well as additional embodiments of air guiding devices 20. Each of these further developments of the air guiding device 20 is characterized by an asymmetry between the front and the rear section 26 and 28.

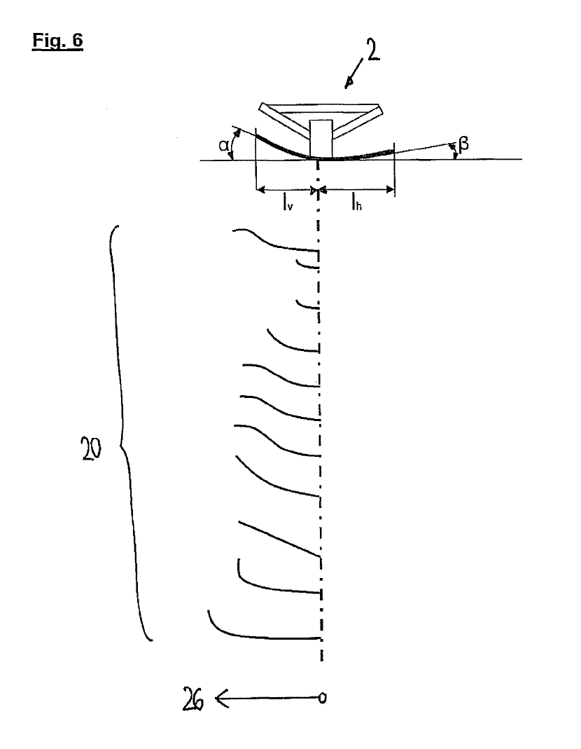

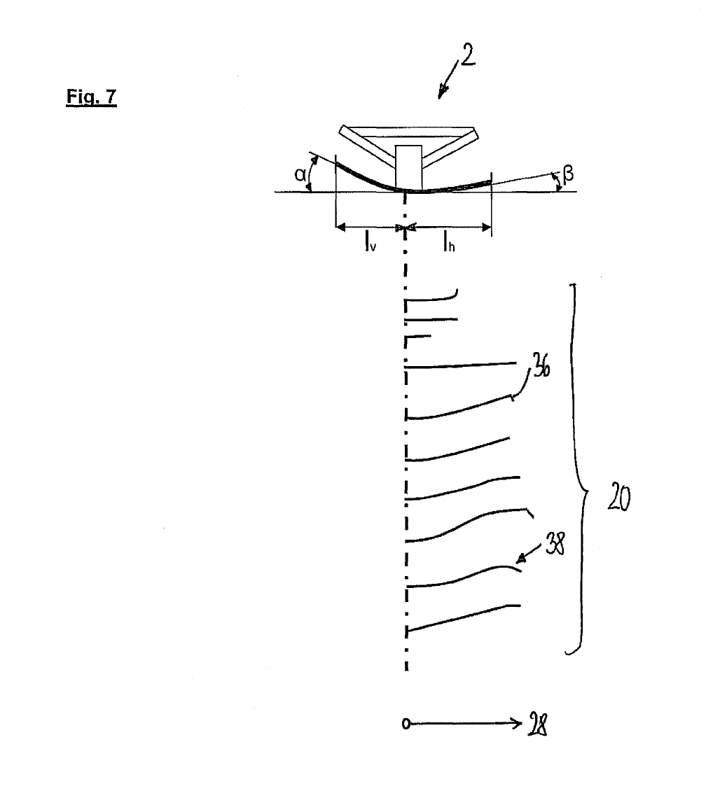

FIG. 6 illustrates contemplated embodiments of front sections 26 of air guiding devices 20 according to the invention.

FIG. 7 illustrates different further developments of the end sections, which face away from the driving direction, of the rear section 28 of air guiding devices 20 according to the invention. For example, a so-called Gurney flap 36 or a countersweep 38 is situated at the rearward end section of the air guiding device.

The sections 26 and 28 respectively, which are illustrated in FIGS. 6 and 7, may definitely be combined with one another in an arbitrary manner.

The embodiments of air guiding devices 20 according to the invention illustrated in FIGS. 5 to 7 vary depending on the design of the underbody 14, 16. The most aerodynamically favorable embodiment in the individual case depends essentially on the local approach flow direction at the start of the air guiding device 20, the speed components in the underbody area and the structure following the air guiding device 20. If the underbody 16 following the rear axle 2 has a smooth shape (diffuser contour), against which the flow is to take place in a low-resistance manner, a direction-indicating flow-off contour is preferred. If the flow is to take place over a fissured underbody 16, a targeted flow breakaway is to be preferred. Since the air guiding device 20 is situated in the rear axle area and therefore definitely in the sphere of influence of a diffuser, a coordination of the length, width and contour of the air guiding device 20 is necessary for the optimal design of the flow against the area situated downstream of the rear axle 2.

The size of the surface of the air guiding device 20 projected in the vertical direction of the vehicle depends on the balance of the air mass flows entering into and exiting from the rear axle cutout, and may therefore vary from one vehicle to the next. It can definitely not be assumed that the aerodynamic drag of the motor vehicle is reduced with an enlargement of the projected surface of the air guiding device 20.

An outlet (passage opening) directly on the air guiding device 20 may possibly also be useful for ventilating the rear axle cutout. Such an outlet, or several such outlets, is or are constructed, for example, in the manner of a ramp in an aerodynamically advantageous form. The expenditures with respect to the ventilation measures will rise if a flowing of air into the rear axle cutout at the forward edge of the air guiding device 20, which faces the driving direction, cannot be sufficiently prevented because of constructional conditions in the underbody area of the motor vehicle.

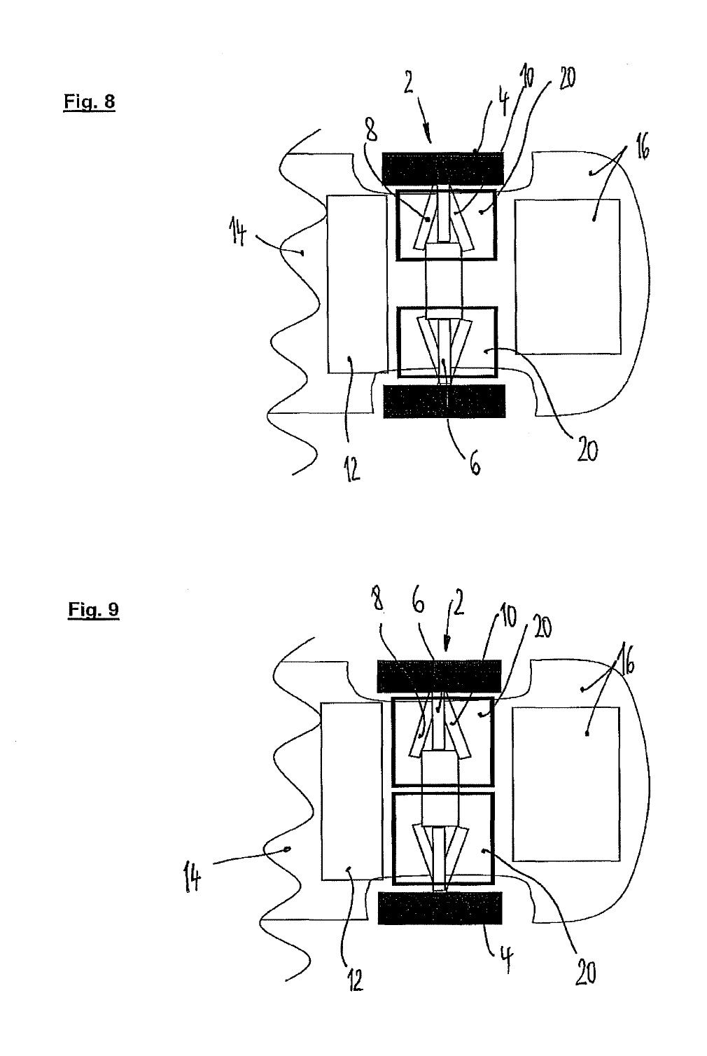

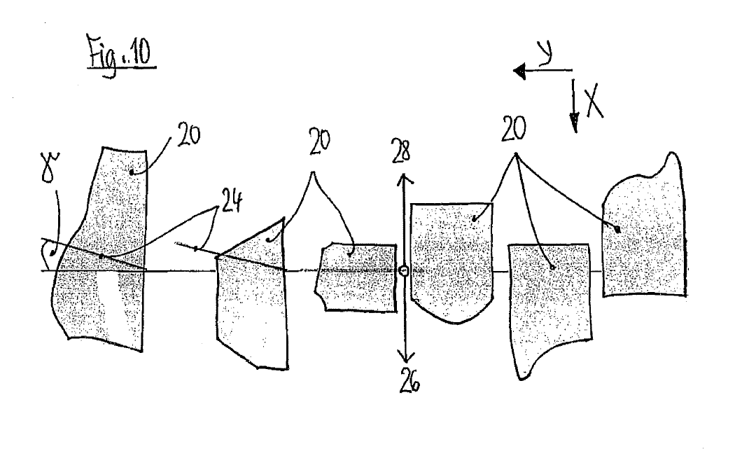

FIGS. 8 and 9 show air guiding devices 20 of different widths in the bottom view of the motor vehicle. While in the embodiment according to FIG. 8, the air guiding devices 20 end approximately with the wheel suspension elements 6, the air guiding device 20 according to the embodiment of FIG. 9 extends to close to the longitudinal center plane of the motor vehicle.

The cross-sections of the air guiding devices 20 according to FIGS. 5 to 7 may vary in the transverse direction Y of the motor vehicle; i.e., the air guiding devices 20 may have different cross-sectional courses along their width dimension.

As illustrated in FIG. 10, the air guiding devices 20 (deviating from the representation of FIGS. 8 and 9) are not necessarily rectangular in a horizontal projection. FIG. 10 illustrates possible further spatial developments of air guiding devices viewed from the bottom, with front and rear sections 26 and 28 respectively of different sizes. FIG. 10 shows clearly that, depending on the application case, the size and/or the shape of the air guiding device according to the invention may differ significantly. The forward and/or rearward edge of the air guiding device 20 may enclose an angle with respect to the transverse direction Y of the motor vehicle or have a curved course (S-shape, bend, etc.).

In contrast to known air guiding devices, the air guiding devices 20 according to the invention are designed in a targeted manner according to aerodynamic aspects and adapt themselves to the course of the underbody 14 and 16 respectively in front of and behind the rear axle 2. They cover a significant cutout of the rear axle 2 in the underbody of the motor vehicle and make a flowing of the underbody flow marked by the arrows 18 into the area of the rear axle cutout more difficult. In addition, the air guiding devices 20 guide the underbody flow 18 with very low flow losses, while avoiding turbulences, along their smooth outer surfaces with low flow losses along the underside of the motor vehicle. Naturally, a secondary effect of the air guiding devices 20 is a protection of the components 6 to 10 of the rear axle 2 as well as additional components (for example, a drive shaft) against splashing water, stone throws, corrosion and other environmental influences during the driving operation. However, the main focus of the further development of the air guiding devices 20 consists of its aerodynamic effectiveness.

As described above, the angle α and β respectively with respect to the horizontal plane 22 is an angle indication for the slope of a median slope line or a median slope plane of the front or of the rear section 26 and 28 respectively of the air guiding device 20.

The transition area 24 between the two sections 26 and 28 does not have to extend precisely in the transverse direction Y of the motor vehicle, but can deviate therefrom by an angle γ, as illustrated in FIG. 10. The angle γ is preferably oriented according to the alignment of that component 6 to 10 of the rear axle 2 to which the air guiding device 20 is fastened. The lower control arm 6 of a rear axle 2, also called a camber control arm, is particularly suitable for the mounting of an air guiding device 20.

The fastening of the air guiding device 20 takes place, for example, by screwing together, by locking into place, by means of expanding rivets, clips, etc.

The air guiding device 20 has limited flexibility in order to, for example, in the case of stress as a result of driving off a curb or when driving over an obstacle of another type, be able to yield to a limited extent and return into its initial position. Sufficient stability also has to exist with respect to “driving through water”. However, a slipping or rotating of the air guiding device 20 with respect to the components 6 to 10 of the rear axle 2 should be prevented constructively in order to ensure a constant defined position of the air guiding device 20 during the entire life of the motor vehicle.

The air guiding device 20 may have additional further developments, for example, bends or additional guiding elements in order to improve the cooling air supply into the area of the service brake at the rear axle 2. In addition, surfaces of the air guiding device 20 close to the wheel may be shaped such that the feeding of cooling air to elements of the brake systems at the rear wheels 4 will be improved.

Summarizing, the invention can be described as follows. At a wheel suspension element 6 of a rear axle 2 of the motor vehicle, which wheel suspension element 6 extends approximately transversely to the longitudinal direction X of a motor vehicle, an air guiding device 20 extends essentially in a horizontal plane 22 and is divided into a front section 26 and a rear section 28. The two sections 26 and 28 respectively extend at different angles α and β with respect to the horizontal plane 22. The air guiding device 20 has an aerodynamically optimized shape and extends from an area behind the underbody 14 or an underbody covering 14 to the trunk bottom 16. The air guiding devices 20 therefore extend in an area in front of the rear axle 2 (section 26) and an area behind the rear axle (section 28). In this case, the projected open surfaces to the cutout of the rear axle 2 in the underbody 14, 16 are partially covered. This makes a flowing of air into the area of the rear axle cutout more difficult. The size and shape of the air guiding device 20 is determined in aerodynamic tests and simulations in several optimization loops, so that differently designed air guiding devices 20 are obtained depending on the vehicle. However, in all cases, this iterative process is based on the recognition according to the invention that the air guiding device 20 has to extend in an area in front of and behind the rear axle 2 and in the two sections 26 and 28 at different angles α and β with respect to a horizontal plane 22. As a result of the size and the shape of the air guiding device 20, particularly in its rear section 28, the flow-off conditions are optimized in a targeted manner to the flow topology of the area behind the rear axle 2 (rearward structure).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air guiding device on a wheel suspension element of a rear axle of a motor vehicle, the wheel suspension element extending approximately transversely to a driving direction of the motor vehicle, the air guiding device comprising:
an air guiding element extending essentially approximately horizontally in an installed position, the air guiding element being divided into a section in front of the rear axle and a section behind the rear axle;
wherein the section in front of the rear axle extends at a different angle from the section behind the rear axle with respect to a horizontal plane, the angle in the section in front of the rear axle being greater than the angle in the section behind the rear axle; and
wherein each section, starting from a transition area between the sections, is oriented in an upward direction.

2. The air guiding device according to claim 1, wherein the transition area between the two sections extends approximately at a level of a lowest area of the wheel suspension element.

3. The air guiding device according to claim 1, wherein a fuel tank is situated in front of the rear axle, a forward edge of the section in front of the rear axle of the air guiding element being arranged behind the fuel tank such that air flow resulting from a drive of the motor vehicle flows around the fuel tank.

4. The air guiding device according to claim 2, wherein a fuel tank is situated in front of the rear axle, a forward edge of the section in front of the rear axle of the air guiding element being arranged behind the fuel tank such that air flow resulting from a drive of the motor vehicle flows around the fuel tank.

5. The air guiding device according to claim 1, wherein a fuel tank is situated in front of the rear axle, a forward edge of the section in front of the rear axle of the air guiding element being arranged above a bottom side of the fuel tank such that air flow resulting from a drive of the motor vehicle flows around the fuel tank.

6. The air guiding device according to claim 2, wherein a fuel tank is situated in front of the rear axle, a forward edge of the section in front of the rear axle of the air guiding element being arranged above a bottom side of the fuel tank such that air flow resulting from a drive of the motor vehicle flows around the fuel tank.

7. The air guiding device according to claim 3, wherein the forward edge of the air guiding element is arranged directly adjacent a back side of the fuel tank facing away from the driving direction.

8. The air guiding device according to claim 5, wherein the forward edge of the air guiding element is arranged directly adjacent a back side of the fuel tank facing away from the driving direction.

9. An air guiding device according to claim 1, wherein in an area of an end section of the air guiding element facing away from the driving direction, a clearance is provided between the air guiding element and an underbody of the motor vehicle.

10. The air guiding device according to claim 1, wherein the air guiding element has a breakaway edge at an end section facing away from the driving direction.

11. The air guiding device according to claim 9, wherein the air guiding element has a breakaway edge at an end section facing away from the driving direction.

12. An air guiding device according to claim 1, wherein the air guiding element has a countersweep at an end section facing away from the driving direction.

13. The air guiding device according to claim 1, wherein the air guiding device extends along a substantial portion of a width of the air guiding element.

14. The air guiding device according to claim 1, wherein the air guiding device extends beyond the wheel suspension element in a direction of a vehicle center.

15. The air guiding device according to claim 1, wherein the air guiding device is operatively configured in an area close to a wheel of the motor vehicle to guide cooling air to at least one component of a wheel brake of the motor vehicle.
